(19) United States
(12) Patent Application Publication
(10) Pub. No.: US 2017/0301448 A1
(43) Pub. Date: Oct. 19, 2017

(54) WIRE SPOOL STRUCTURE OF MAGNETIC ELEMENT AND WIRE WINDING METHOD THEREOF

(71) Applicant: INNOTRANS TECHNOLOGY CO., LTD., Taipei City (TW)

(72) Inventor: Tsung-Han CHOU, Keelung (TW)

(21) Appl. No.: 15/099,241

(22) Filed: Apr. 14, 2016

(51) Int. Cl. H01F 7/20; H01F 41/076

(52) U.S. Cl. CPC H01F 7/20; H01F 41/076

(57) ABSTRACT

A wire spool structure of a magnetic element includes at least one wire winding portion, a plurality of wire exit portions and a plurality of conductive pins. The wire winding portion is adapted to be wound by at least one wire. The wire exit portions are consecutively arranged at one side of the wire winding portion. Each wire exit portion includes a channel including an exit, and at least one metal pin disposed correspondingly to the exit and adapted to be wound by the wire. Each of the conductive pins is disposed correspondingly to one of the wire exit portions, inserted into the channel after the end of the wire is wound on the metal pin, and caused to be partially protrude from the exit to correspond to the metal pin. The conductive pin and the wire are welded by a welding material to form an electrical connection.

### FIELD OF THE INVENTION

The present invention relates to a wire spool structure of a magnetic element and a wire winding method thereof, and particularly to a wire spool structure that facilitates wire winding of a magnetic element and a wire winding method thereof

### BACKGROUND OF THE INVENTION

Current wire spool structures, such as disclosures of the Taiwan Patent Nos. 1501266, 1493578, 1471879, M502237 and M491933, include a wire winding portion and a plurality of wire exit portions. The wire winding portion allows at a least one wire to be wound thereon. Each of the wire exit portions includes a plurality of fixed conductive pins. After the wire is completely wound, the end of the wire may be placed at the exit portion and be welded with the conductive pin to form an electrical connection. However, in current wire spool structures, the conductive pins are fixedly provided on the wire spool structure after the wire spool structure is manufactured. As such, during a wire winding process, a user needs to particularly pay attention to positions of the conductive pins, and to whether these conductive pins properly coordinate with currently used wire winding tools. Such complications disfavor the application of the conventional wire spool structure.

The Applicant previously raised a coil winding structure including an aluminum conductor, as disclosed by the Taiwan Patent No. 1501270. The coil winding structure includes a wire spool, at least one aluminum conductor, and a plurality of copper inserting members. The wire spool includes at least one wire winding region. The aluminum conductor includes a coil winding section that surrounds the wire winding region by at least one turn, and two connecting sections at ends of the aluminum conductor. Each of the copper inserting members includes a clamping portion covering the connecting section, and an inserting portion inserted into a connecting hole. During the implementation of a winding process, the aluminum conductor is first wound for at least one turn at the wire winding region, and the end of the aluminum conductor is assembled with the copper inserting member. The copper inserting member may be installed on the wire spool in advance, or may be installed on the wire spool after having been assembled with the aluminum conductor. If the copper inserting member is installed on the wire spool in advance, during the implementation of the winding process, the wire spool is affected by the copper inserting members to result in the foregoing issue of a disfavored winding process. If the copper inserting member is installed on the wire spool after having been assembled with the aluminum conductor, the aluminum conductor requires a longer reserved segment for the user to readily connect the aluminum conductor with the copper inserting member. Thus, the segment having an excessively reserved length may cause lax coil winding and affect electrical characteristics. In addition, the above implementation is unsuitable for a wire spool having a minute size or including a large number of pins, hence leading in application limitations.

Thus, in an implementation of a winding process of conventional wire spool structures, these wire spool structures are generally limited by conductive pins, such that the winding process cannot be smoothly performed.

### SUMMARY OF THE INVENTION

The primary object of the present invention is to solve the winding issue caused by conductive pins in a conventional wire spool structure.

To achieve the above object, the present invention provides a wire spool structure of a magnetic element. The wire spool structure of the present invention includes at least one wire winding portion, a plurality of wire exit portions and a plurality of conductive pins. The wire winding portion is adapted to be wound by at least one wire. The wire exit portions are consecutively arranged at one side of the wire winding portion. Each of the wire exit portions includes a channel including an exit, and at least one metal pin corresponding to one of the exits and adapted to be wound by the wire. Each of the conductive pins is disposed correspondingly to one the wire exit portions, inserted into the channel after the end of the wire is wound on the metal pin to partially protrude from the exit to correspond to the metal pin, and welded to the wire by a welding material to form an electrical connection.

In one embodiment, the wire spool structure is formed by two half housings, which jointly define and form the wire winding portion and the wire exit portions.

In one embodiment, each of the wire exit portions is provided with a plurality of metal pins surrounding the exit.

In one embodiment, the metal pin is a tinned copper clad steel wire.

In one embodiment, each of the wire exit portions includes an installation groove disposed correspondingly to one of the exits to allow the metal pin to be inserted therein.

In addition to the above wire spool structure of a magnetic element, the present invention further provides a wire winding method of a magnetic element. The wire winding method includes following steps.

In step 1, a wire spool structure is provided. The wire spool structure includes at least one wire winding portion, a plurality of wire exit portions, and a plurality of conductive pins. The wire exit portions are consecutively arranged at one side of the wire winding portion. Each of the wire exit portions includes a channel including an exit, and at least one metal pin corresponding to one of the exits and adapted to be wound by a wire.

In step 2, the wire is provided and wound around the wire winding portion for at least one turn, such the end of the wire exits at the wire exit portion and is wound on the metal pin.

In step 3, one of the conductive pins is correspondingly inserted in the channel of the wire exit portion wound by the end of the wire, such that the conductive pin is partially placed in the channel and the remaining part of the conductive pin protrudes from the exit to correspond to the metal pin.

In step 4, the conductive pin, the metal pin and the wire are welded by a welding material to form an electrical connection.

In one embodiment, step 3 further includes a sub-step of adjusting the conductive pin protruding from the exit to an extent that the conductive pin is connectable to a circuit board.

In one embodiment, step 1 further includes a sub-step of causing the metal pin to be inserted in a installation groove of the wire exit portion disposed correspondingly to the exit.

With the above technical solutions, the present invention provides following features compared to the prior art. In the present invention, only after the wire is wound on the wire winding portion, the conductive pin is inserted into the channel, and the conductive pin is caused to partially protrude from the channel to correspond to the metal pin. The wire is then welded with the part of the conductive pin protruding from the channel to form an electrical connection. Thus, during the implementation of a wire winding process, a user is able to smoothly perform the winding process without having to additionally consider the position of the conductive pin.

### BRIEF DESCRIPTION OF THE DRAWINGS

FIG. 1 is an appearance schematic diagram according to an embodiment of the present invention;

FIG. 2 is an exploded structural schematic diagram according to an embodiment of the present invention;

FIG. 3 is a partial sectional schematic diagram according to an embodiment of the present invention;

FIG. 4 is a flowchart of a process according to an embodiment of the present invention;

FIG. 5 is a first implementation schematic diagram according to an embodiment of the present invention;

FIG. 6 is a second implementation schematic diagram according to an embodiment of the present invention;

FIG. 7 is a flowchart of a process according to another embodiment of the present invention; and

FIG. 8 is a third implementation schematic diagram according to an embodiment of the present invention.

### DETAILED DESCRIPTION OF THE PREFERRED EMBODIMENTS

Details and technical contents of the present invention are given with the accompanying drawings below.

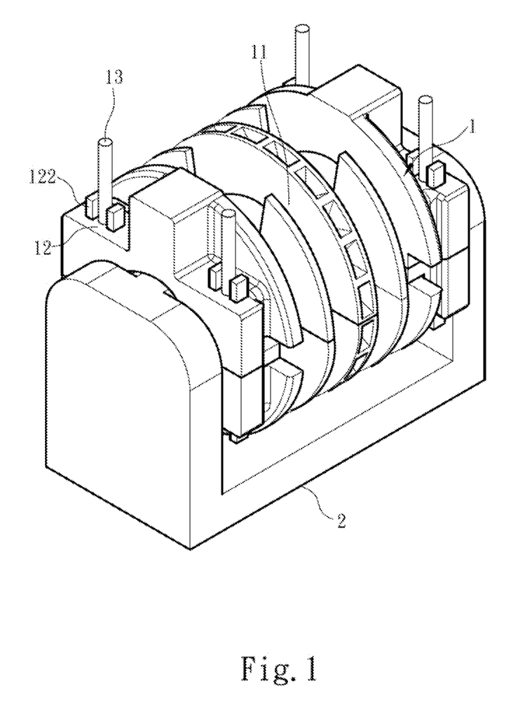

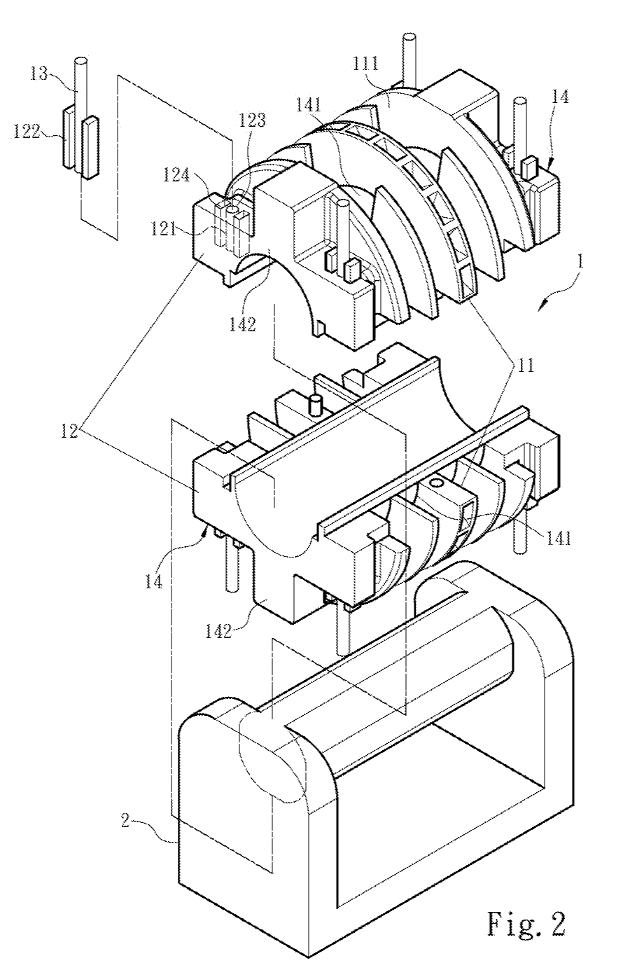

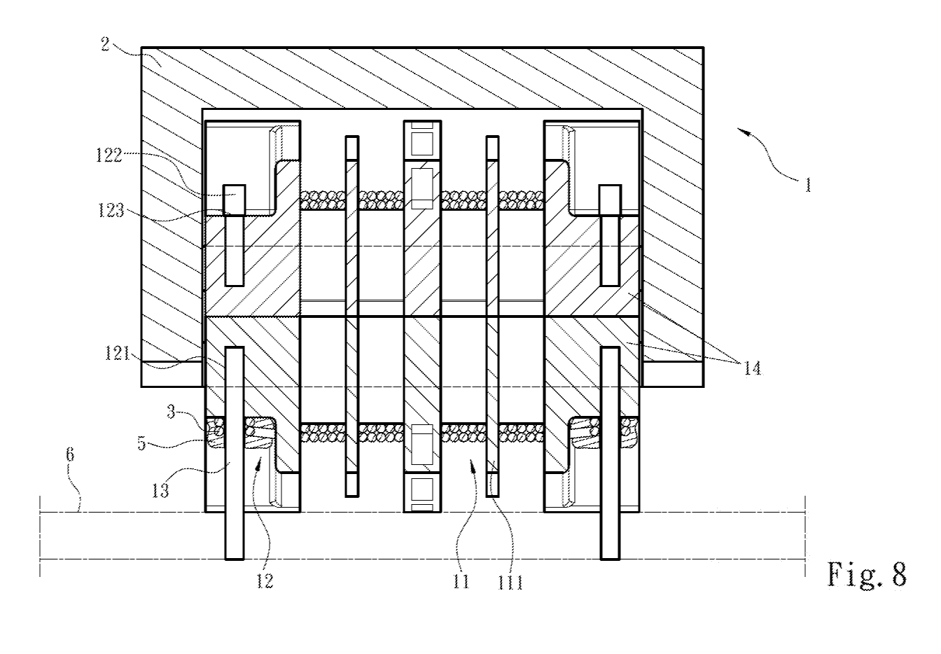

Referring to FIG. 1 to FIG. 3 and FIG. 8, a wire spool structure 1 of a magnetic element is provided according to an embodiment of the present invention. The wire spool structure 1 is adapted to be assembled with a core 2 to form the magnetic element. The wire spool structure 1 includes at least one wire winding portion 11, a plurality of wire exit portions 12 and a plurality of conductive pins 13. The wire winding portion 11 is adapted to be wound by at least one wire 3. The wire 3 may be wound on the wire winding portion 11 for at least one turn according to application requirements, and may be an enameled wire or a triple insulated wire. Further, the wire winding portion 11 may include at least one partitioning plate 111. The partitioning plate 111 divides the wire winding portion 11 into a plurality of wire winding regions, such that the wire 3 is allowed to wind in each of the wire winding regions to form a plurality of wire coils. Further, the thickness and form of the partitioning plate 111 may be appropriately adjusted according to insulation safety regulations of the magnetic element with respect to the wire coil.

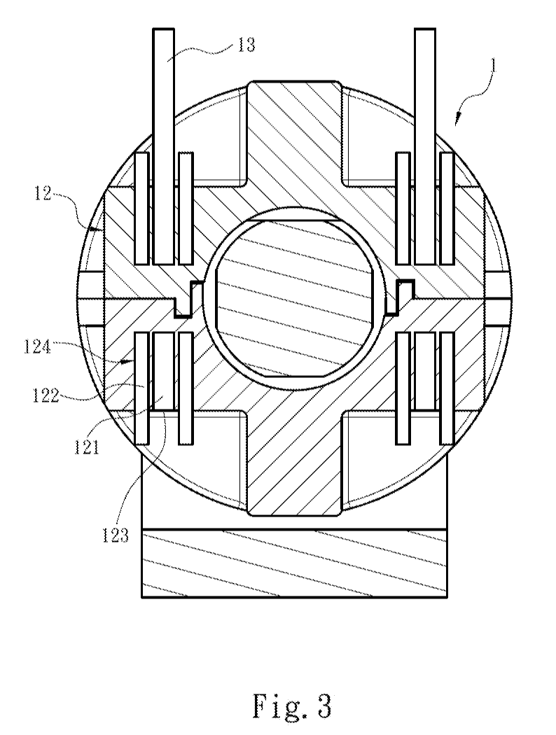

The wire winding portion 11 and the wire exit portions 12 of the present invention are a formed integral, and the wire exit portions 12 are consecutively arranged at one side of the wire winding portion 11. Taking the embodiment in FIG. 1 for example, the wire exit portions 12 are located at two sides of the wire winding portion 11. Each of the wire exit portions 12 includes a channel 121 and a metal pin 122. The channel 121 is provided at the wire exit portion 12 along an axial direction, and includes an exit 123. The metal pin 122 is disposed correspondingly to the exit 123, and is not an integral extended from the wire exit portion 12. Further, each of the wire exit portions 12 includes at least one installation groove 124 disposed correspondingly to one of the exits 123. The installation groove 124 allows the metal pin 122 to be inserted therein, and has an inner diameter that can be adjusted according to the size of the metal pin 122 to cause the metal pin 122 to form close coordination with the installation groove 124 and to reliably secure the metal pin 122. In the present invention, the main purpose of the metal pin 122 is to bridge the wire 3 and the conductive pin 13 instead of serving for connection purposes of other structures. Thus, the length of the metal pin 122 is further limited, in a way that the metal pin 122 does not protrude relative to the wire spool structure, as shown in FIG. 3. In addition, the rigidity of the metal pin 122 of the present invention is capable of withstanding a restoring pulling force generated after the end of the wire 3 is wound. Further, the metal pin 122, being a metal material, allows the wire 3, the metal pin 122 and the conductive pin 13 to be more readily welded to one another. In one embodiment, the metal pin 122 of the present invention may be implemented by a copper clad steel wire (commonly referred to as a CP wire). In another embodiment of the present invention, each of the wire exit portions 12 includes a plurality of metal pins 122 that surround the exit 123. For example, the wire exit portion 12 includes two metal pins 122, which are respectively disposed at two opposite ends of the wire exit portion 12 to assist the insertion of the conductive pin 13.

Each of the conductive pins 13 of the present invention is disposed correspondingly to one of the wire exit portions 12, and is configured to be inserted into the channel 121 and adapted to receive a force and move appropriately. The configuration of the conductive pins 13 may be appropriately adjusted according to the configuration of the channel 121, but is not limited to conforming only the configuration of the channel 121. More specifically, in the present invention, each of the conductive pins 13 is adapted to be smoothly inserted into the channel 121, and so the diameter or size of each of the conductive pins 13 is designed to be at least conforming to the inner diameter of the channel 121. Further, the conductive pins 13 are not placed in the channel 121 at the beginning of the winding process of the wire spool structure, and are only inserted into the channel 121 after the winding process is complete.

Referring to FIG. 1 to FIG. 3, in one embodiment, the wire spool structure 1 is formed by two half housing 14, which jointly define and form the wire winding portion 11 and the wire exit portions 12. More specifically, the two half housings 14 are corresponding structures. Each of the two half housings 14 includes a semi-ring 141 and two seats 142 respectively connected to the sides of the semi-ring 141. When the two half housings 14 are assembled with each other, the two semi-rings 141 of the two half housings 14 jointly form the wire winding portion 11, and the seats 142 of the two half housings 14 jointly form the wire exit portions 12.

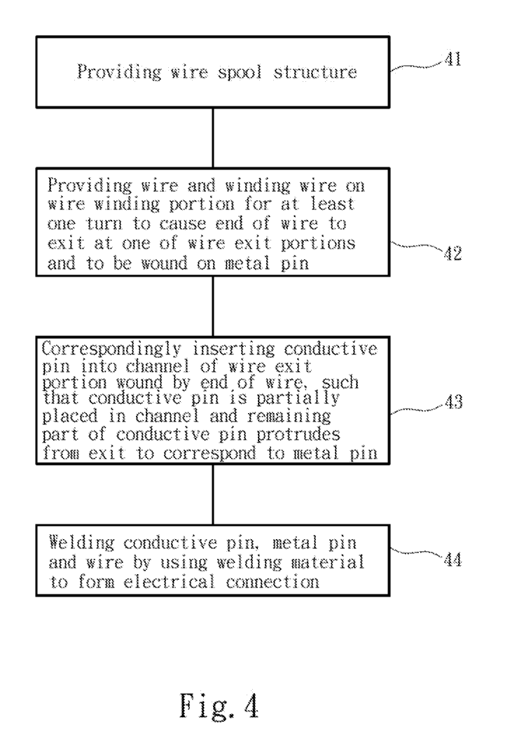

Referring to FIG. 4, in addition to the above wire spool structure 1, the present invention further discloses a wire winding method performed by the wire spool structure 1. The wire winding method includes following steps.

In step 1 (41), the wire spool structure 1 is provided. The wire spool structure 1 includes the at least one wire winding portion 11, the wire exit portions 12 and the conductive pins 13. The wire exit portions 12 are consecutively arranged at one side of the wire winding portions 11. Each of the wire exit portions 12 includes the channel 121 and the at least one metal pin 122. The end of the channel 121 is the exit 123. The metal pin 122 is disposed correspondingly to the exit 123 and is adapted to be wound by the wire 3.

In step 2 (42), the wire 3 is provided and wound around the wire winding portion 11 for at least one turn, such that the end of the wire 3 exits at the wire exit portion 12 and is wound on the metal pin 122.

In step 3 (43), one of the conductive pins 13 is correspondingly inserted into the channel 121 of the wire exit portion 12 wound by the end of the wire 3, such that the conductive pin 13 is partially placed in the channel 121 and the remaining part of the conductive pin 13 protrudes from the exit 123 to correspond to the metal pin 122.

In step 4 (44), the conductive pin 13, the metal pin 122 and the wire 3 are welded by using a welding material 5 to form an electrical connection.

More specifically, at the beginning of performing the wire winding method, the wire spool structure 1 is first provided, and the wire 3 is wound around the wire winding portion 11 for at least one turn to form the wire coil. The end of the wire 3 is then wound on the metal pin 122 to complete tucking in the wire 3. The method next proceeds to step 3 (43). At the beginning of step 3 (43), one of the conductive pins 13 is inserted into the channel 121 of the wire exit portion 12 wound by the end of the wire 3, and the conductive pin 13 is caused to protrude towards the metal pin 122 wound by the end of the wire 3, followed by performing step 4 (44). Using a welding operation, the wire 3, the metal pin 122 and the part of the conductive pin 13 protruding from the exit 123 may form an electrical connection. For example, a welding material 5 (e.g. tin) used in the welding operation may completely enclose the metal pin 122, or may partially weld the wire 3, the metal pin 122 and the part of the conductive pin 13 protruding from the exit 123. Thus, the winding process is complete.

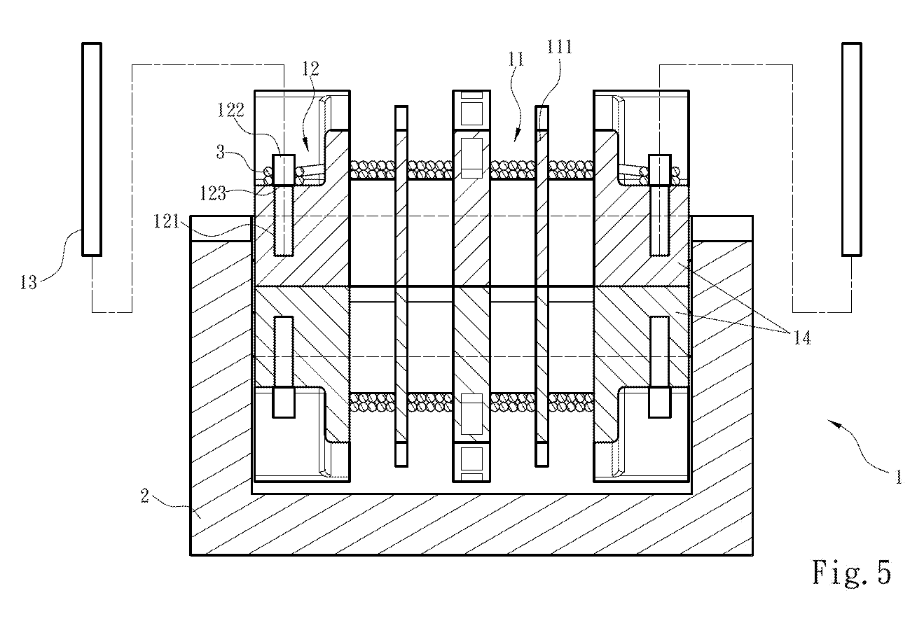

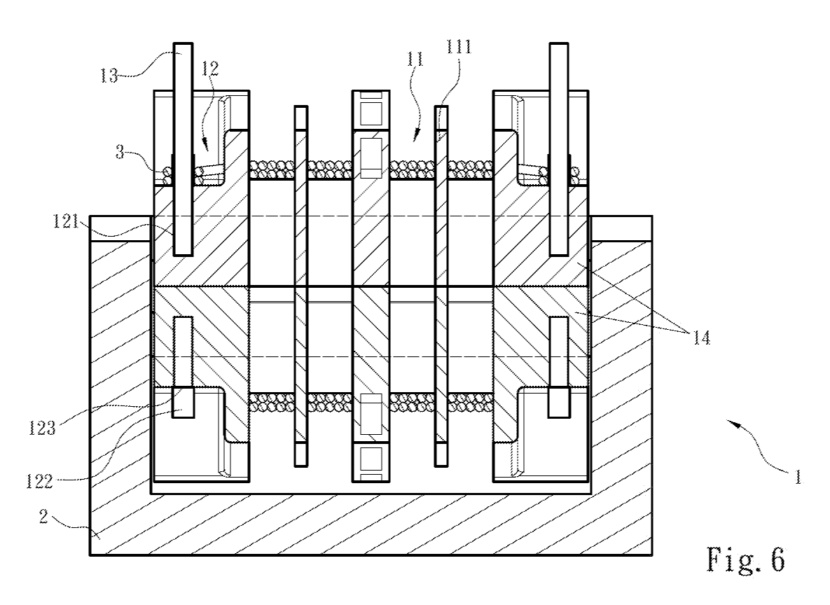

Further, as shown in FIG. 5 and FIG. 6, the direction along which the conductive pin 13 is inserted into the channel 121 is depicted. As shown, the conductive pin 13 is inserted into the channel 121 from the metal pin 122 wound by the end of the wire 3 through the corresponding exit 123, and the extent the conductive pin 13 placed in the channel 121 is adjusted to allow the conductive pin 13 to be welded with the wire 3 and the metal pin 122. In one embodiment, step 3 (43) further includes a sub-step 431, in which the conductive pin 13 protruding from the exit 123 is adjusted to an extent that the conductive pin 13 is connectable to a circuit board 6. After it is ensured that the winding process is complete, the magnetic element may be electrically connected to the circuit board 6 through the conductive pin 13.

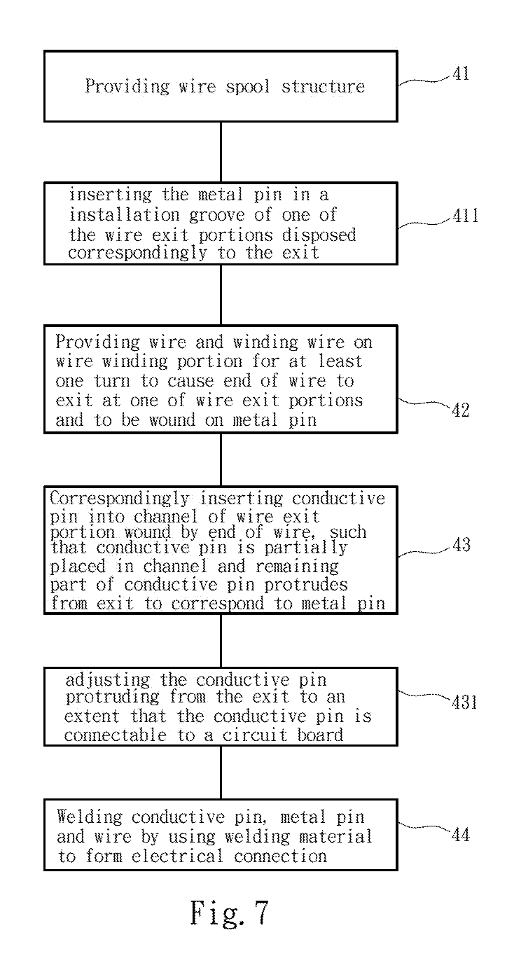

Referring to FIG. 7, step 1 (41) of the wire winding method of the present invention further includes a sub-step 411, in which the metal pin 122 is inserted into the installation groove 124 of one of the wire exit portions 12 disposed correspondingly to the exit 123. More specifically, after the wire winding portion 11 and the wire exit portion 12 of the present invention are manufactured, the metal pin 122 is not disposed on the wire exit portion 12. The metal pin 122 is inserted into the installation groove 124 of the wire exit portion 12 at the beginning of the wire winding process, and the metal pin 122 is configured not to protrude relative to the wire winding portion 11.

What is claimed is:

1. A wire spool structure of a magnetic element, comprising:
at least one wire winding portion, adapted to be wound by at least one wire;
a plurality of wire exit portions, consecutively arranged at one side of the wire winding portion, each of the wire exit portions comprising a channel provided at the wire exit portion and including an exit, and at least one metal pin disposed correspondingly to the exit and adapted to be wound by the wire; and
a plurality of conductive pins, each of the conductive pins disposed correspondingly to one of the wire exit portions, inserted into the channel after an end of the conductive pin is wound by the end of the wire, such that the conductive pin partially protrudes from the exit to correspond to the metal pin and is welded to the wire by a welding material to form an electrical connection.

2. The wire spool structure of a magnetic element of claim 1, formed by two half housings, wherein the wire winding portion and the wire exit portions are jointly defined and formed by the two half housings.

3. The wire spool structure of a magnetic element of claim 2, wherein each of the wire exit portions is provided with a plurality of metal pins that surround the exit.

4. The wire spool structure of a magnetic element of claim 2, wherein the metal pin is a tinned copper clad steel wire.

5. The wire spool structure of a magnetic element of claim 2, wherein each of the wire exit portions comprises at least one installation groove disposed correspondingly to one of the exits and allowing the metal pin to be inserted therein.

6. A wire winding method of a magnetic element, comprising steps of:
step 1: providing a wire spool structure, the wire spool structure comprising at least one wire winding portion, a plurality of wire exit portions and a plurality of conductive pins, the wire exit portions consecutively arranged at one side of the wire winding portion, each of the wire exit portions comprising a channel disposed at the wire winding portion and including an exit, and at least one metal pin disposed correspondingly to the exit and adapted to be wound by a wire;
step 2: providing and winding the wire around the wire winding portion for at least one turn, such that the end of the wire exits at one of the wire exit portions and is wound on the metal pin;
step 3: inserting one of the conductive pins into the channel of the wire exit portion wound by the end of the wire, such that the conductive pin is partially placed in the channel and the remaining part of the conductive pin protrudes from the exit to correspond to the metal pin; and
step 4: welding the conductive pin, the metal pin and the wire by using a welding material to form an electrical connection.

7. The wire winding method of a magnetic element of claim 6, wherein step further comprises a sub-step of:
adjusting the conductive pin protruding from the exit to an extent that the conductive pin is connectable to a circuit board.

8. The wire winding method of a magnetic element of claim 7, wherein step further comprises a sub-step of:
inserting the metal pin in a installation groove of one of the wire exit portions disposed correspondingly to the exit.

9. The wire winding method of a magnetic element of claim 8, wherein the metal pin is a tinned copper clad steel wire. 10
